(19) United States
(12) Patent Application Publication
(10) Pub. No.: US 2003/0125062 A1
(43) Pub. Date: Jul. 3, 2003

(54) Method and apparatus for providing status information associated with a plurality of users

(76) Inventors: Charles W. Bethards, Colleyville, TX (US); Garland Phillips, Arlington, TX (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/034,409

(22) Filed: Dec. 27, 2001

(51) Int. Cl. H04B 7/00

(52) U.S. Cl. 455/517; 455/414; 455/445

(57) ABSTRACT

In accordance with the preferred embodiments of the present invention, a method (400) and an apparatus (e.g., mobile station (160)) for providing status information associated with a plurality of users of real-time communication service: The mobile station (160) provides a plurality of logon identifiers associated with a first subscriber. Each of the plurality of logon identifiers corresponds to one of the plurality of users so that the plurality of users may access real-time communication service via the first subscriber. The plurality of logon identifiers may be, but is not limited to, a first name, a last name, a persona, an IP address, and a port number. The mobile station (160) monitors status associated with the plurality of logon identifiers to provide status information. The status information may be, but is not limited to, information indicating one of on-line, off-line, busy, away, on-the-phone, out-to-lunch, and nearby. Accordingly, the mobile station (160) transmits the status information associated with one of the plurality of logon identifiers to a second subscriber having a contact list including the one of the plurality of logon identifiers.

### FIELD OF THE INVENTION

The present invention relates generally to communication systems, and more particularly, to a method and an apparatus such as a mobile station for providing status information associated with a plurality of users of real-time communication service.

### BACKGROUND OF THE INVENTION

A wireless communication system is a complex network of systems and elements. Typically elements include (1) a radio link to the mobile stations (e.g., cellular telephones), which is usually provided by at least one and typically several base stations, (2) communication links between the base stations, (3) a controller, typically one or more base station controllers or centralized base station controllers (BSC/CBSC), to control communication between and to manage the operation and interaction of the base stations, (4) a call controller or switch, typically a call agent (i.e., a “softswitch”), for routing calls within the system, and (5) a link to the land line or public switch telephone network (PSTN), which is usually also provided by the call agent.

For many people, the Internet has provided alternative ways of communication. In particular, electronic mail messages (i.e., e-mail) have replaced traditional letters and sometimes voice calls as a way of communicating. However, e-mail may not provide a response fast enough in certain circumstances. Further, multiple exchanges of e-mails may require a number of steps to read, reply, and send the e-mails back and forth. Accordingly, real-time communication service such as instant messaging (IM) service and group chat service is becoming a communication mechanism to substitute for e-mail. For example, instant messaging service permits a subscriber to determine whether other subscribers such as friends or co-workers are on-line, and if so, to communicate with each other in “real time” over the Internet. Under most circumstances, real-time communication is “instant.” Even during peak traffic periods of the Internet, the delay of real-time communication is typically less than a few seconds. Thus, subscribers may have a real-time on-line “conversation” by exchanging messages with each other (i.e., sending messages back and forth). For example, parents may be able to “talk” with their children who are attending college or working in other cities, states, or countries via real-time communication service. As a result, real-time communication service may even replace voice calls because of cost and convenience.

Typically, a household (e.g., a family, roommates, etc.) with multiple users may share a single Internet subscription, i.e., the multiple users may access real-time communication service as a single subscriber. All of the users are identified as the single subscriber. That is, when one of the multiple users engages in real-time communication service, the user is simply identified as the subscriber, i.e., that particular user is not distinguished from other users. For example, User #1 and User #2 may access real-time communication service as Subscriber #1 (i.e., User #1 and User #2 share the use of Subscriber #1) but only User #1 is logged on. Other subscribers, such as friends of User #2, may wish to participate in instant messaging communication with User #2 but they do not know that User #1 rather than User #2 is logged on as Subscriber #1 because current systems simply indicates that Subscriber #1 is logged on without indicating the status of each user. Thus, other subscribers may not be able to distinguish between multiple users of a subscriber. Even with multiple logon identifiers for different users to access real-time communication service via a subscriber, current systems typically provide the status of the user who is logged on (i.e., “on-line”) whereas other users who are not logged on are simply shown as “off-line.” For example, User #1 may be logged on, i.e., “on-line” and User #2 may not be logged on but nearby. Even though User #2 is nearby, User #2 is shown as “off-line” to other subscribers. That is, status information associated with users who are not logged on may not be provided to other subscribers.

One aspect of designing a wireless communication system is to provide real-time communication service to mobile stations, i.e., wireless devices such as cellular telephones, pagers, and electronic planners. However, wireless devices have resource limitations including screen size and power constraints. Such limitations may restrict the use of real-time communication to a single application. For example, multiple users of a wireless device may have to share a single instant messaging application on a wireless device to participate in real-time communication.

Further, wireless devices may be charged for communication that is not normally experienced by wired devices. This cost for communication may affect when and how often a wireless device user may participate in real-time communication. For example, a wireless device user may choose not to participate in real-time communication with a wired device user during peak traffic periods of the Internet when the cost is higher than other times. Accordingly, the wireless device user may not respond to a message sent by the wired device user during that time. As a result, the wired device user may not know why the wireless device user did not respond to the message.

Therefore, a need exists for a method and an apparatus to provide status information associated with a plurality of users of the real-time communication service.

### BRIEF DESCRIPTION OF THE DRAWINGS

FIG. 1 is a block diagram representation of a wireless communication system that may be adapted to operate in accordance with the preferred embodiments of the present invention.

FIG. 2 is a block diagram representation of a communication network that may be adapted to operate in accordance with the preferred embodiments of the present invention.

FIG. 3 is a block diagram representation of a mobile station that may be adapted to operate in accordance with the preferred embodiments of the present invention.

FIG. 4 is a visual representation of status information associated with a plurality of users that may be generated in accordance with the preferred embodiments of the present invention.

FIG. 5 is a flow diagram representation of a method for providing status information associated with a plurality of users in accordance with the preferred embodiments of the present invention.

### DETAIL DESCRIPTION OF THE PREFERRED EMBODIMENTS

A method and an apparatus (e.g., a mobile station) for providing status information associated with a plurality of users of real-time communication service in a communication system is described herein. The communication system is adapted to provide real-time communication service such as instant messaging service and group chat service to a plurality of subscribers. The mobile station provides a plurality of logon identifiers associated with a first subscriber. Each of the plurality of logon identifiers corresponds to one of the plurality of users so that the plurality of users may access real-time communication service via the first subscriber. The plurality of logon identifiers may be, but is not limited to, a first name, a last name, a persona, an IP address, and a port number. For example, a family or roommates may share a single subscriber account with a logon identifier for each user to access real-time communication service via a common wireless device such as a cellular telephone, a pager, and an electronic planner (e.g., a personal digital assistant (PDA)). The mobile station monitors status associated with the plurality of logon identifiers to provide status information. The status information may be, but is not limited to, information indicating one of on-line, off-line, busy, away, on-the-phone, out-to-lunch, and nearby. For example, the mobile station may monitor status associated with the plurality of logon identifiers to provide information indicating one of the plurality of users is “on-line” based on a registration for real-time communication service. Further, the mobile station may monitor status associated with the plurality of logon identifiers to provide status information based on a user input via, for example, an alphanumeric keypad, a numeric keypad, a touch-sensitive display and a microphone. To illustrate this concept, the mobile station may monitor status associated with the plurality of logon identifiers to provide information indicating one of the plurality of users is “busy” in response to the user pressing a button of an alphanumeric keypad on a cellular telephone (i.e., the button represents a “busy” status). Accordingly, the mobile station transmits the status information associated with one of the plurality of logon identifiers to a second subscriber with a contact list including that particular logon identifier. The contact list may be stored at, but not limited to, a memory within a communication network.

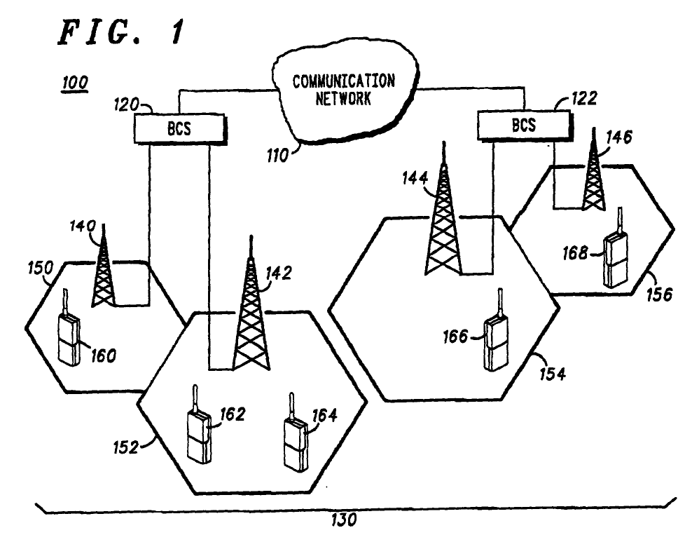

A communication system in accordance with the present invention is described in terms of several preferred embodiments, and particularly, in terms of a wireless communication system operating in accordance with at least one of several communication standards. These standards include analog, digital or dual-mode communication system protocols such as, but not limited to, the Advanced Mobile Phone System (AMPS), the Narrowband Advanced Mobile Phone System (NAMPS), the Global System for Mobile Communication (GSM), the IS-55 Time Division Multiple Access (TDMA) digital cellular, the IS-95 Code Division Multiple Access (CDMA) digital cellular, CDMA 2000, the Personal Communications System (PCS), 3G, General Packet Radio Services (GPRS) and variations and evolutions of these protocols. As shown in FIG. 1, a wireless communication system 100 includes a communication network 110, a plurality of base station controllers (BSC), generally shown as 120 and 122, servicing a total service area 130. The wireless communication system 100 may be, but is not limited to, a frequency division multiple access (FDMA) based communication system, a time division multiple access (TDMA) base communication system, and a code division multiple access (CDMA) based communication system. As is known for such systems, each BSC 120 and 122 has associated therewith a plurality of base stations (BS), generally shown as 140, 142, 144, and 146, servicing communication cells, generally shown as 150, 152, 154, and 156, within the total service area 130. The BSCs 120 and 122, and BSs 140, 142, 144, and 146 are specified and operate in accordance with the applicable standard or standards for providing wireless communication services to mobile stations (MS), generally shown as 160, 162, 164, 166, and 168 operating in communication cells 150, 152, 154, and 156, and each of these elements are commercially available from Motorola, Inc. of Schaumburg, Ill.

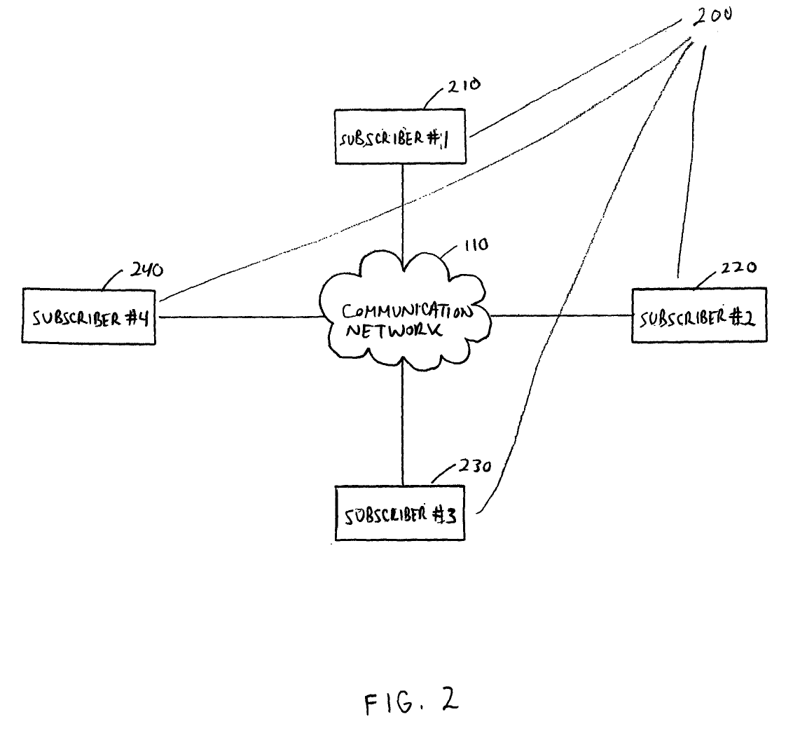

Referring to FIG. 2, the communication network 110 may be, but is not limited to, an Internet Protocol (IP) network such as a General Packet Radio Services (GPRS) network. The communication network 110 is operable to provide real-time communication service such as instant messaging service and group chat service to a plurality of subscribers 200, generally shown as Subscriber #1 210, Subscriber #2 220, Subscriber #3 230, and Subscriber #4 240. For example, the communication network 110 provides exchange of, but not limited to, text-only messages between the plurality of subscribers 200.

A basic flow for providing status information associated with a plurality of users of real-time communication service that may be applied with the preferred embodiment of the present invention shown in FIG. 2 may start with a subscriber (e.g., Subscriber #1 210) providing a plurality of logon identifiers associated with the subscriber. Each of the plurality of logon identifiers corresponds to one of the plurality of users so that the plurality of users may access real-time communication service via the subscriber. For example, Subscriber #1 may provide a logon identifier “Tom” to User #1 and a logon identifier “Matt” to User #2. The communication network 110 receives status information associated with each of the plurality of logon identifiers from the subscriber. Thus, the communication network 110 may be operable to provide status information associated with a particular logon identifier to another subscriber with a contact list including the particular logon identifier. The contact list may be stored in a memory within the communication network 110. To illustrate this concept, Subscriber #2 may have a contact list including the logon identifiers “Tom” and “Matt,” Subscriber #3 may have a contact list including the logon identifier “Tom” and Subscriber #4 may have a contact list including the logon identifier “Matt.” Accordingly, the communication network 110 provides status information based on the contact lists of the Subscribers #2 #4. That is, the communication network 110 provides status information associated with logon identifiers “Tom” and “Matt” to Subscriber #2, status information associated with logon identifier “Tom” to Subscriber #3 and status information associated with logon identifier “Matt” to Subscriber #4.

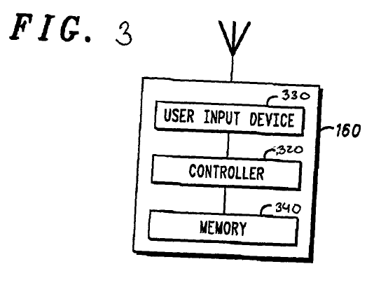

Referring to FIG. 3, the mobile station 160 (e.g., a cellular telephone) generally includes a controller 320, a user-input device 330, and a memory 340. The mobile station 160 may be operable to provide real-time communication service, such as instant messaging service and group chat service, to a subscriber with a plurality of logon identifiers. For example, the mobile station 160 provides for, but is not limited to, an exchange of text-only messages between a plurality of subscribers. The controller 320 is operatively coupled to the user-input device 330, which may be, but is not limited to, an alphanumeric keypad, a numeric keypad, a touch-sensitive display and a microphone. Also, the controller 320 is operatively coupled to the memory 340, which stores a program or a set of operating instructions. Accordingly, the controller 320 executes the program or the set of operating instructions such that the mobile station 160 operates in accordance with a preferred embodiment of the invention. The program or the set of operating instructions may be embodied in a computer-readable medium such as, but not limited to, paper, a programmable gate array, application specific integrated circuit, erasable programmable read only memory, read only memory, random access memory, magnetic media, and optical media. Alternatively, the mobile station 160 may be a wireless device such as, but not limited to, a pager and an electronic planner (i.e., personal digital assistant (PDA)).

A basic flow for providing status information associated with a plurality of users of real-time communication service that may be applied with the preferred embodiment of the present invention shown in FIG. 3 may start with the mobile station 160 providing a plurality of logon identifiers associated with a first subscriber. Each of the plurality of logon identifiers corresponds to one of the plurality of users so that the plurality of users may access real-time communication service via the first subscriber. The plurality of logon identifiers, may be, but is not limited to, a first name (e.g., Matt and Tom), a last name (e.g., Smith), a persona (e.g., Joe/work and Joe/leisure), an IP address, and a port number. The mobile station 160 is operable to provide real-time communication service to the plurality of users via the plurality of logon identifiers associated with the first subscriber. That is, each of the plurality of users may access real-time communication service via the first subscriber by using a logon identifier associated with that particular user. For example, a household with multiple users may share a single subscriber account but each user may have a distinct logon identifier to access instant messaging service (i.e., the users do not share a logon identifier). The mobile station 160 monitors status associated with the plurality of logon identifiers to provide status information. Status information may include, but is not limited to, information indicating one of on-line, off-line, busy, away, on-the-phone, out-to-lunch, and nearby. In particular, a user is “on-line” when the user is logged on and available to participate in real-time communication; a user is “off-line” when the user is logged off and not available to participate in real-time communication; a user is “busy,” “away,” “on-the-phone” or “out-to-lunch” when the user is logged on but not available to participate in real-time communication; and a user is “nearby” when the user is logged on and available but not currently participating in real-time communication. For example, the mobile station 160 may monitor status associated with the plurality of logon identifiers to provide information indicating a status of “on-line” in response to a registration for real-time communication service. The mobile station 160 may also monitor status associated with the plurality of logon identifiers to provide status information based on a user input via the user-input device 330. For example, a user may select a status (e.g., busy) by pressing a button on an alphanumeric keypad that corresponds to the particular status. The mobile station 160 may detect the user input via the alphanumeric keypad and provide information indicating that the user is busy based on the user input. Accordingly, the mobile station 160 transmits the status information associated with one of the plurality of logon identifiers to a second subscriber with a contact list including the particular logon identifier. To illustrate this concept, a first user and a second user may use the first subscriber to access real-time communication service such that a first logon identifier corresponds to the first user and a second logon identifier corresponds to the second user. The second subscriber may have a contact list including the first logon identifier but not the second logon identifier. Thus, the mobile station 160 transmits status information associated with the first logon identifier to the second subscriber so that the second subscriber may be informed of the status of the first user. For example, the status information associated with the first logon identifier may be information indicating “on-line” (i.e., first user is on-line). The status information may be displayed on a wireless device (e.g., mobile station 162 shown in FIG. 1) or a wired device (e.g., a desk computer and a laptop computer) operated by the second subscriber. As a result, the second subscriber may participate in real-time communication with the first user based on the status information. Alternatively, the contact list may include the second logon identifier so that the second subscriber may also be informed of the status of the second user.

In an alternate embodiment, an apparatus for providing status information associated with a plurality of users may be integrated into a communication network such as the communication network 110 shown in FIG. 1. The apparatus generally includes a controller and a memory as described above. The communication network 110 may be, but is not limited to, an Internet Protocol (IP) network, a General Packet Radio Services (GPRS) network, a 2.5G network, and a 3G network.

Referring to FIG. 4, a visual representation of status information 410 adapted in accordance with a preferred embodiment of the present invention to provide status information of a plurality of users of real-time communication services is illustrated. The status information associated with a logon identifier may be displayed on, but is not limited to, a device operated by a subscriber. Each of the plurality of users operating the mobile station 160 is associated with one of a plurality of logon identifiers 415. A status corresponding to each of the plurality of logon identifiers 415 may be provided to other subscribers. For example, a status of “on-line” 420 may indicate that a user associated with a logon identifier of“Matt” 425 is logged on and available to participate in real-time communication. A status of “busy” 430 may indicate that a user associated with a logon identifier of “Tom” 435 is logged on but not available to participate in real-time communication. A status of “nearby” 440 may indicate that a user associated with a logon identifier of “Joe/work” 445 is also logged on and even though the user is not currently participating in real-time communication, the user may become available to participate in real-time communication. Further, a status of “off-line” 450 may indicate that a user associated with a logon identifier of “Joe/leisure” 455 is not logged on. As noted above, the logon identifier may be a persona, e.g., “Joe/work” 445 and “Joe/leisure” 455, so that a single user may have multiple logon identifiers. For example, a user (e.g., Joe) associated with both the logon identifiers “Joe/work” 445 and “Joe/leisure” 455 may have a contact list for work and a contact list for leisure, respectively, that the user may use to participate in real-time communication. To further illustrate this concept, the status information associated with the logon identifier “Joe/work” 445 may be transmitted to subscribers with “Joe/work” on their contact lists 460, and the status information associated with the logon identifier “Joe/leisure” 455 may be transmitted to subscribers with “Joe/leisure” on their contact lists 470. Thus, the subscribers with the logon identifier “Joe/work” on their contact lists 460 may be informed that Joe is nearby whereas subscribers without the logon identifier “Joe/work” on their contact lists may not receive status information associated with the logon identifier “Joe/work” 445 (i.e., status information 440). Accordingly, the status information associated the logon identifier “Joe/leisure” 455 (i.e., status information 450) may be transmitted to the subscribers with “Joe/leisure” on their contact lists 470 informing them that Joe is off-line but not transmitted to subscribers without “Joe/leisure” on their contact lists. As a result, the subscribers with “Joe/work” on their contact lists 460 may attempt to participate in real-time communication with Joe whereas the subscribers with “Joe/leisure” on their contact lists 470 may not attempt to do so.

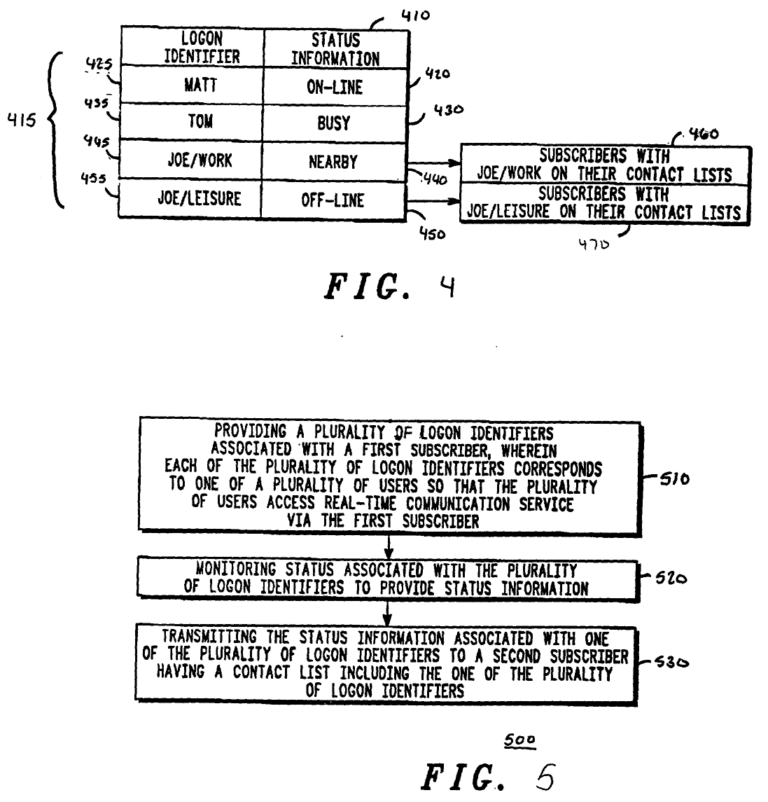

In accordance with the preferred embodiments of the present invention, and with references to FIG. 5, a method 500 for providing status information associated with a plurality of users of real-time communication service is shown. Method 500 begins at step 510, where a mobile station provides a plurality of logon identifiers associated with a first subscriber. In particular, the plurality of logon identifiers may be, but is not limited to, a first name, a last name, a persona, an IP address, and a port number. Each of the plurality of logon identifiers corresponds to one of the plurality of users so that the user accesses the real-time communication service via the first subscriber. The real-time communication service may be, but is not limited to, instant messaging service and group chat service. At step 520, the mobile station monitors status associated with the plurality of logon identifiers to provide status information. The status information may be, but is not limited to, information indicating one of on-line, off-line, busy, away, on-the-phone, out-to-lunch, and nearby. At step 530, the mobile station transmits the status information associated with one of the plurality of logon identifiers to a second subscriber with a contact list that includes the logon identifier. For example, the logon identifier “Joe/work” may be included on a contact list of the second subscriber. Accordingly, the mobile station transmits the status information associated with the logon identifier “Joe/work” to the second subscriber. As a result, the second subscriber may proceed to engage in real-time communication with the user corresponding to the logon identifier based on the status information.

Many changes and modifications could be made to the invention without departing from the fair scope and spirit thereof. The scope of some changes is discussed above. The scope of others will become apparent from the appended claims.

What is claimed:

1. In a communication system, the communication system adapted to provide real-time communication service to a plurality of subscribers, a method for providing status information associated with a plurality of users comprising:
providing a plurality of logon identifiers associated with a first subscriber, each of the plurality of logon identifiers corresponding to one of the plurality of users so that the plurality of users access real-time communication service via the first subscriber;
monitoring status associated with the plurality of logon identifiers to provide status information; and
transmitting the status information associated with one of the plurality of logon identifiers to a second subscriber, the second subscriber having a contact list including the one of the plurality of logon identifiers.

2. The method of claim 1, wherein the step providing a plurality of logon identifiers associated with a first subscriber comprises providing one of a first name, a last name, a persona, an IP address, and a port number corresponding to one of the plurality of users.

3. The method of claim 1, wherein the step of monitoring status associated with the plurality of logon identifiers to provide status information comprises monitoring status associated with one of a first name, a last name, a persona, an IP address, and a port number to provide status information.

4. The method of claim 1, wherein the step of monitoring status associated with the plurality of logon identifiers to provide status information comprises monitoring status associated with the plurality of logon identifiers to provide status information based on a registration.

5. The method of claim 1, wherein the step of monitoring status associated with the plurality of logon identifiers to provide status information comprises monitoring status associated with the plurality of logon identifiers to provide status information based on a user input via one of an alphanumeric keypad, a numeric keypad, a touch-sensitive display and a microphone.

6. The method of claim 1, wherein the step of monitoring status associated with a plurality of logon identifiers to provide status information comprises monitoring status associated with a plurality of logon identifiers to provide information indicating one of on-line, off-line, busy, away, on-the-phone, out-to-lunch, and nearby.

7. The method of claim 1, wherein the step of monitoring status associated with the plurality of logon identifiers to provide status information comprises monitoring status associated with a plurality of logon identifiers from a wireless device to provide status information, and wherein the wireless device comprises one a cellular telephone, a pager, and an electronic planner.

8. The method of claim 1, wherein the step of transmitting the status information associated with one of the plurality of logon identifiers to a second subscriber comprises transmitting information indicating one of on-line, off-line, busy, away, on-the-phone, out-to-lunch, and nearby to a second subscriber.

9. The method of claim 1, wherein the communication system is adapted to provide one of instant messaging service and group chat service to the plurality of subscribers.

10. In a communication system, the communication system adapted to provide real-time communication service to a plurality of subscribers, wherein an apparatus is adapted to provide status information associated with a plurality of users, the apparatus comprising;
a memory;
a processor operatively coupled to the memory, the processor being operable to provide a plurality of logon identifiers associated with a first subscriber;
the processor being operable to monitor status associated with the plurality of logon identifiers to provide status information; and
the processor being operable to transmit the status information associated with one of the plurality of logon identifiers to a second subscriber having a contact list including the one of the plurality of logon identifiers,
wherein each of the plurality of logon identifiers corresponds to one of the plurality of users so that the plurality of users access real-time communication service via the first subscriber.

11. The apparatus of claim 10, wherein the communication system is adapted to provide one of instant messaging service and group chat service to the plurality of subscribers.

12. The apparatus of claim 10, wherein the controller comprises a controller operable to monitor status associated with the plurality of logon identifiers to provide status information based on a registration.

13. The apparatus of claim 10, wherein the controller comprises a controller operable to monitor status associated with the plurality of logon identifiers to provide status information based on a user input via one of an alphanumeric keypad, a numeric keypad, a touch-sensitive display and a microphone.

14. The apparatus of claim 10, wherein the plurality of logon identifiers comprises one of a first name, a last name, a persona, an IP address, and a port number corresponding to one of the plurality of users.

15. The apparatus of claim 10, wherein the status information comprises information indicating one of the plurality of users being one of on-line, off-line, busy, away, on-the-phone, out-to-lunch, and nearby.

16. The apparatus of claim 10, wherein the status information comprises status information associated with one of a first name, a last name, a persona, an IP address, and a port number corresponding to one of the plurality of users.

17. The apparatus of claim 10, wherein the apparatus comprises one of a cellular telephone, a pager, an electronic planner, and a communication network.

18. The apparatus of claim 10, wherein the apparatus is integrated into an Internet Protocol (IP) network, a General Packet Radio Services (GPRS) network, a 2.5G network, and a 3G network.

19. In a communication system adapted to provide real-time communication service to a plurality of subscribers, wherein a controller operates in accordance with a computer program embodied on a computer-readable medium for providing status information associated with a plurality of users, the computer program comprising:
a first routine that directs the controller to provide a plurality of logon identifiers associated with a first subscriber, each of the plurality of logon identifiers corresponding to one of the plurality of users so that the plurality of users access real-time communication service via the first subscriber;
a second routine that directs the controller to monitor status associated with the plurality of logon identifiers to provide status information; and
a third routine that directs the controller to transmit the status information associated with one of the plurality of logon identifiers to a second subscriber, the second subscriber having a contact list including the one of the plurality of logon identifiers.

20. The computer program of claim 19, wherein the first routine comprises a routine that directs the controller to provide one of a first name, a last name, a persona, an IP address, and a port number corresponding to one of a plurality of users.

21. The computer program of claim 19, wherein the second routine comprises a routine that directs the controller to monitor status associated with one of a first name, a last name, a persona, an IP address, and a port number to provide status information.

22. The computer program of claim 19, wherein the second routine comprises a routine that directs the controller to monitor status associated with the plurality of logon identifiers to provide status information based on a registration.

23. The computer program of claim 19, wherein the second routine comprises a routine that directs the controller to monitor status associated with the plurality of logon identifiers to provide status information based on a user input via one of an alphanumeric keypad, a numeric keypad, a touch-sensitive display and a microphone.

24. The computer program of claim 19, wherein the second routine comprises a routine that directs the controller to monitor status associated with a plurality of logon identifiers to provide information indicating one of on-line, off-line, busy, away, on-the-phone, out-to-lunch, and nearby.

25. The computer program of claim 19, wherein the second routine comprises a routine that directs the controller to monitor status associated with a plurality of logon identifiers from a wireless device to provide status information, and wherein the wireless device comprises one a cellular telephone, a pager, and an electronic planner.

26. The computer program of claim 19, wherein the third routine comprises a routine that directs the controller to transmit information indicating one of on-line, off-line, busy, away, on-the-phone, out-to-lunch, and nearby associated with one of the plurality of logon identifiers to a second subscriber having a contact list including the one of the plurality of logon identifiers.

27. The computer program of claim 19, wherein the communication system is adapted to provide one of instant messaging service and group chat service to the plurality of subscribers.

28. The computer program of claim 19, wherein the medium comprises one of paper, a programmable gate array, application specific integrated circuit, erasable programmable read only memory, read only memory, random access memory, magnetic media, and optical media.
